(19) United States
(12) Patent Application Publication
(10) Pub. No.: US 2026/0309425 A1
(43) Pub. Date: Oct. 8, 2026

(54) SHEET MEMBRANE APPARATUS

(71) Applicant: Baltimore Aircoil Company, Inc., Jessup, MD (US)

(72) Inventors: Kevin Ellsworth Egolf, Hampstead, MD (US); Ellie M. Litwack, Columbia, MD (US); Russell Phillips, Crownsville, MD (US)

(21) Appl. No.: 19/481,425

(22) PCT Filed: May 2, 2024
(86) PCT No.: PCT/US2024/027378

§ 371 Date: Nov. 4, 2025

Related U.S. Application Data
(60) Provisional application No. 63/464,445, filed on May 5, 2023.

(51) Int. Cl. F28D 1/02; F28D 21/00; F28F 3/10; F28F 9/22; F28F 9/26

(52) U.S. Cl. CPC F28D 1/024; F28D 21/0015; F28F 3/10; F28F 9/22; F28F 9/26; F28F 2230/00; F28F 2240/00; F28F 2250/08

(57) ABSTRACT

In one aspect, a sheet membrane apparatus including a first sheet membrane and a second sheet membrane to be contacted by a first fluid. The sheet membrane apparatus has an interior intermediate the first and second sheet membranes to receive a second fluid. The first and second sheet membranes are configured to permit mass transfer between the first and second fluids via the first and second sheet membranes. The sheet membrane apparatus includes a seal member between the first and second sheet membranes and a clamp configured to urge the first and second sheet membranes together to engage the first and second sheet membranes with the seal member.

### CROSS-REFERENCE TO RELATED APPLICATION

This application claims the benefit of U.S. Provisional Application No. 63/464,445, filed May 5, 2023, which is hereby incorporated herein by reference in its entirety

### FIELD

This disclosure relates to heat and/or mass exchangers and, more specifically, to heat and/or mass exchangers having sheet membranes.

### BACKGROUND

Heat exchangers come in a wide variety of configurations and are used in a wide variety of industries. Some heat exchangers include membranes to facilitate heat transfer. One example is a sheet membrane heat exchanger having membrane sheets arranged in pairs. The pairs of sheet membranes have inner surfaces spaced apart to receive a first fluid therebetween, such as water. The pairs of sheet membranes have outer surfaces across which a second fluid, such as air, is directed. Heat and/or mass transfers between the first and second fluids through the sheet membranes.

Sheet membranes have been used for heat transfer, desiccant dehumidification, alcohol dehydration, and filtration as a few examples. Some of these sheet membranes include rigid, porous membranes that may be unsuitable for some applications. Other sheet membranes have low burst pressures and are prone to leaking. These shortcomings of existing membrane systems have limited the use of sheet membranes in some fields.

### SUMMARY

In one aspect of the present disclosure, a sheet membrane apparatus is provided that includes a first sheet membrane and a second sheet membrane to be contacted by a first fluid and an interior intermediate the first and second sheet membranes to receive a second fluid. The first and second sheet membranes are configured to permit mass transfer between the first and second fluids via the first and second sheet membranes. The sheet membrane apparatus further includes a seal member between the first and second sheet membranes and a clamp configured to urge the first and second sheet membranes together to engage the first and second sheet membranes with the seal member. The first and second sheet membranes may be slippery and flexible, and the clamp engages the seal member with the first and second sheet membranes to form a seal between the first and second sheet membranes and the seal member. Further, the second fluid in the interior may be pressurized, such as greater than 10 psi, and the clamp inhibits the pressurized second fluid seeping between the sheet membranes and the seal member.

The present disclosure also provides a sheet membrane system that includes an airflow generator such as a fan, an inlet header, an outlet header, and a plurality of sheet membrane cassettes configured to receive a fluid from the inlet header and direct the fluid toward the outlet header. The sheet membrane cassettes each include a first sheet membrane and a second sheet membrane to be contacted by air moved by the airflow generator. The sheet membrane cassettes each have an interior defined at least in part by the first and second sheet membranes to receive the fluid and a seal member between the first and second sheet membranes and engaged therewith. Further, the sheet membrane cassettes have supports on opposite sides of the first and second sheet membranes, the supports keeping the first and second sheet membranes engaged with the seal member. The sheet membranes may elongate, expand, or otherwise change shape when contacted by the fluid in the interiors of the sheet membrane cassettes. The supports are capable of securely keeping the sheet membranes engaged with the seal member despite changes in the shape of the sheet membranes upon wetting of the sheet membranes by fluid in the interiors of the sheet membrane cassettes.

The present disclosure also provides a method of assembling a sheet membrane cassette. The method includes positioning a seal member between a first sheet membrane and a second sheet membrane, the seal member and first and second sheet membranes forming at least a portion of an interior of the sheet membrane cassette. The method includes providing a fluid inlet and a fluid outlet of the sheet membrane cassette. Further, the method includes clamping the seal member between the first and second sheet membranes to engage the seal member with the first and second membranes and form a fluid-resistant connection therebetween. The method thereby facilitates assembling a sheet membrane cassette having a fluid-resistant connection between sheet membranes, which may be slippery and/or flimsy, and are difficult to secure together using conventional approaches.

### BRIEF DESCRIPTION OF THE DRAWINGS

FIG. 1 is a schematic view of a heat exchanger system having a plurality of sheet membrane cassette assemblies.

FIG. 2A is a perspective view of a sheet membrane cassette assembly of FIG. 1 including membrane cassettes.

FIG. 2B is a front view of the sheet membrane cassette assembly of FIG. 2A.

FIG. 2C is a side elevational view of the sheet membrane cassette assembly of FIG. 2A.

FIG. 3 is a partially exploded, perspective view of the sheet membrane cassette assembly of FIG. 2A.

FIG. 4A is a perspective view of one of the sheet membrane cassettes of the sheet membrane cassette assembly of FIG. 2A.

FIG. 4B is an exploded view of the sheet membrane cassette of FIG. 4A.

FIG. 5 is a cross-sectional view of a portion of the sheet membrane cassette of FIG. 4A taken along line 5 -5 in FIG. 4A.

FIG. 6 is a perspective view of an outer frame of the sheet membrane cassette of FIG. 4A.

FIG. 7 is a perspective view of an inlet port and outlet port in communication with an interior formed between sheet membranes of the membrane cassette of FIG. 4A.

FIG. 8A is a schematic, cross-sectional view of a periphery of the sheet membrane cassette according to another embodiment that includes a central frame.

FIG. 8B is a schematic, elevational view of the central frame of FIG. 8A including an inlet port and an outlet port.

FIG. 9A is a schematic, side cross-sectional view of a sheet membrane cassette according to another embodiment that includes one or more spacers between sheet membranes of the membrane cassette.

FIG. 9B is a schematic, front cross-sectional view of the spacers of FIG. 9A according to one embodiment.

FIG. 10A is a side schematic view of sheet membranes of adjacent sheet membrane cassettes having increased spacing between the sheet membrane cassettes to limit contact between the sheet membranes of the adjacent sheet membrane cassettes.

FIG. 10B is a side schematic view of sheet membranes of adjacent sheet membrane cassettes having an alternating bulging arrangement that facilitates positioning the sheet membrane cassettes closer together.

FIG. 10C is a side schematic view of sheet membranes of adjacent sheet membrane cassettes having an increased density of supports along the frames of the sheet membrane cassettes to limit contact between the sheet membranes of adjacent sheet membrane cassettes.

FIG. 10D is a side schematic view of sheet membranes of adjacent sheet membrane cassettes having a more rigid membrane material to limit contact between the sheet membranes of adjacent sheet membrane cassettes.

FIG. 11A is a schematic, side cross-sectional view of a periphery of a sheet membrane cassette according to another embodiment that includes a baffle plate between sheet membranes of the sheet membrane cassette.

FIG. 11B is a perspective view of the baffle plate of FIG. 11A.

FIG. 11C is a side elevational view of the baffle plate of FIG. 11A.

### DETAILED DESCRIPTION

In one aspect, a sheet membrane cassette assembly is provided that includes a plurality of sheet membrane cassettes and passageways between the sheet membrane cassettes. The sheet membrane cassettes receive a first fluid and the passageways receive a second fluid. The sheet membrane cassettes each have sheet membranes with an interior therebetween that receives the first fluid. The sheet membranes are configured to facilitate mass and/or heat transfer between the first and second fluids. Further, each sheet membrane cassette includes a seal layer extending about a periphery of the first and second sheet membranes, Each sheet membrane cassette further includes first and second frame members that engage the seal layer with the periphery of the first and second sheet membranes. The engaged seal layer and sheet membranes form a fluid-tight seal between the sheet membranes. The sheet membrane apparatus may include securing layers between the first sheet membrane and first frame member and between the second sheet membrane and second frame member which provides a secure connection between the sheet membranes and the first and second frame members. In one embodiment, the seal layer includes a first seal layer intermediate the first frame member and one of the sheet membranes and a second seal layer intermediate the second frame member and another sheet membrane. The sheet membrane cassette assembly may be configured for use in various fields, such as heat transfer, liquid desiccant dehumidification, carbon capture, membrane vacuum dehumidification, and pervaporation (e.g., alcohol dehydration or distillation).

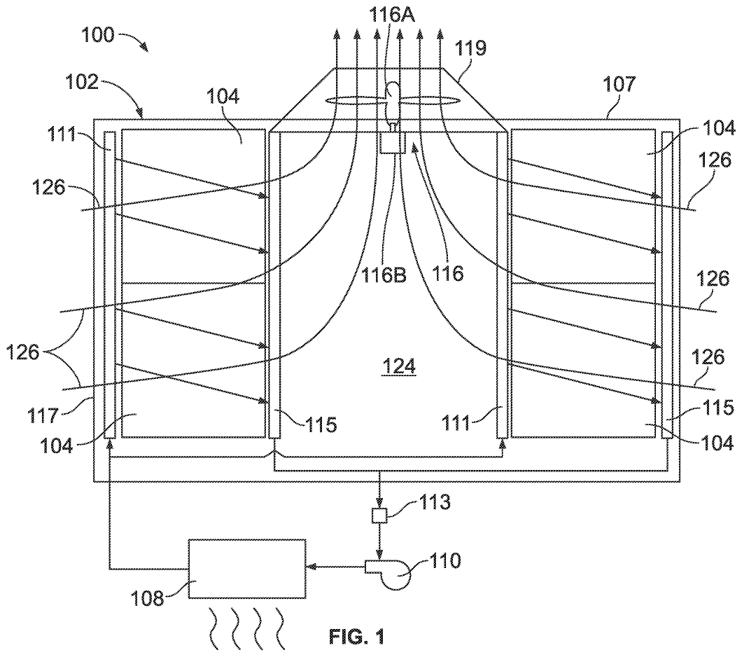

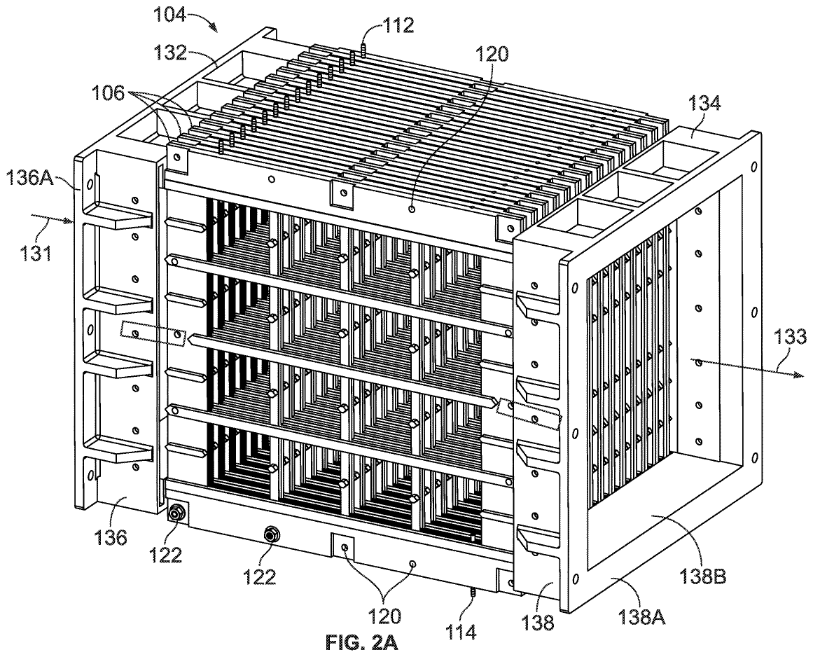

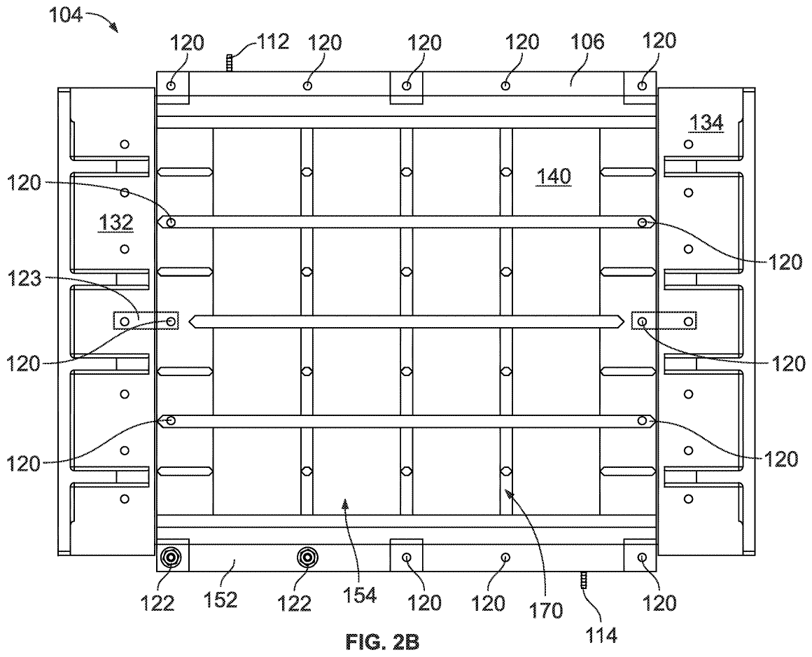

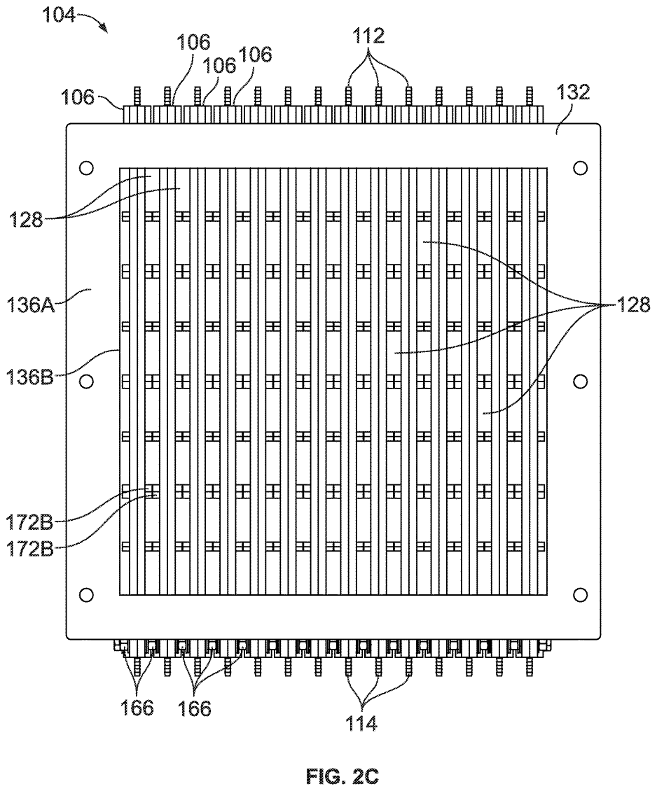

Regarding FIG. 1, a heat exchanger system 100 is provided that includes a first heat exchanger 102 and a second heat exchanger 108. The heat exchanger 102 may include one or more sheet membrane cassette assemblies 104. The sheet membrane cassette assemblies 104 each comprise a plurality of heat exchanger cassettes, such as sheet membrane cassettes 106 (see FIG. 2A). The heat exchanger 108 receives heat, such as heat from an industrial process or from cooling a building, and transfers the heat to a working fluid such as water or a water/glycol mixture of the heat exchanger system 100. The fluid may include liquid and gas, the proportions of which may vary as the working fluid travels throughout the heat exchanger system 100. The heat exchanger system 100 includes one or more pumps, such as pump 110, operable to pump the fluid from the heat exchanger 108 to the heat exchanger 102 and from the heat exchanger 102 to the heat exchanger 108. The fluid is pumped from heat exchanger 108 to inlet headers 111 of the heat exchanger 102 and through the membrane cassettes 106 to outlet headers 115 of the heat exchanger 102. The heat exchanger 102 includes an airflow generator, such as one or more fan assemblies 116, operable to draw air through the sheet membrane cassette assemblies 104 to remove heat from the fluid flowing through the membrane cassettes 106 as discussed in further detail below. The cooled fluid is pumped by the pump 110 from the outlet headers 115 of the membrane cassettes 106 to the heat exchanger 108. The heat exchanger system 100 may further include a fluid supply 113 that adds fluid, such as liquid, gas, or a liquid/gas mixture, to the system 100 to compensate for the fluid permeating out of the membrane cassettes 106 as discussed below.

The sheet membrane cassette assemblies 104 may be within an outer structure or housing 107 of the heat exchanger 102. The heat exchanger 102 may include multiple sheet membrane cassette assemblies 104 to provide a desired cooling capacity of the heat exchanger 102. As shown in FIG. 1, the sheet membrane cassette assemblies 104 may be stacked on one another. While two sheet membrane cassette assemblies 104 are shown in a stack, in other embodiments, three or more sheet membrane cassette assemblies 104 may be stacked upon one another. The heat exchanger 102 includes two or more stacks of the sheet membrane cassette assemblies 104 separated by an air passage 124. The fan assembly 116 may include a motor 116A coupled to a fan 116B. The motor 116A may be operated to rotate the fan 116B to move air generally along paths 126 into the housing 107 via inlets 117, through the sheet membrane cassette assemblies 104, upward through the air passage 124, and out of the heat exchanger 102 via outlet 119. Movement of the air through the sheet membrane cassette assemblies 104 removes heat from the fluid in the sheet membrane cassette assemblies 104.

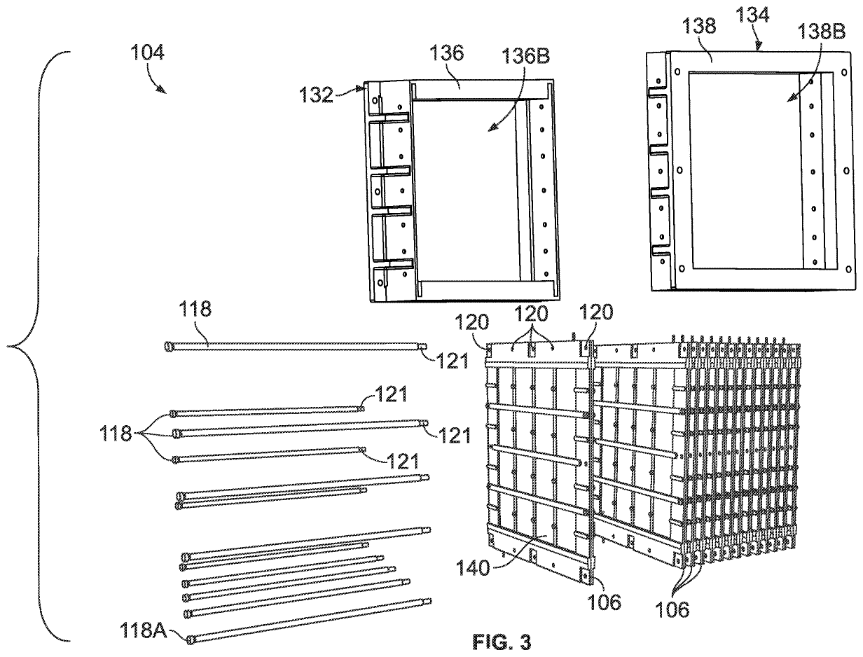

With respect to FIGS. 2A-3, one of the sheet membrane cassette assemblies 104 is shown. The sheet membrane cassette assembly 104 includes a plurality of sheet membrane apparatuses such as membrane cassettes 106. The membrane cassettes 106 may be arranged side-by-side and connected together to form an array of membrane cassettes 106. For example, connector rods 118 (see FIG. 3) are extended through attachment openings 120 of the membrane cassettes 106 to couple the stacked membrane cassettes 106 together. Each connector rod 118 may include a threaded end portion 121 to which a nut 122 (see FIG. 2A) may be threaded to secure the membrane cassettes 106 together.

The sheet membrane cassette assembly 104 includes a plurality of air flow passageways 128 (see FIG. 2C) between the membrane cassettes 106. The fan assembly 116 is operated to move air through the air flow passageways 128 and along sheet membranes 140, 142 of the membrane cassettes 106 as discussed below to cool the fluid flowing through the membrane cassettes 106.

The sheet membrane cassette assembly 104 includes an air inlet frame 132 and an air outlet frame 134. The air inlet frame 132 has a sleeve portion 136 for directing air toward the stacked membrane cassettes 106. The air inlet frame 132 has a flange 136A with one or more openings to receive fasteners for mounting the sheet membrane cassette assembly 104 in the first heat exchanger 102. The air inlet frame 132 has an air inlet opening 136B through which air flows before entering the air flow passageways 128 between the membrane cassettes 106.

The air outlet frame 134 is similar to the air inlet frame 132 and includes a sleeve portion 138, a flange 138A, and an air outlet opening 138B. The sleeve portion 138 collects air flowing out of the air flow passageways 128 and directs the collected air toward the air passage 124. In this manner, airflow is directed in direction 131 into the sheet membrane cassette assembly 104 and exits the sheet membrane cassette assembly 104 in direction 133, The air inlet frame 132 and air outlet frame 134 may be connected to the stacked membrane cassettes 106 by, for example, brackets 123 and fasteners. In one embodiment, the sheet membrane cassette assemblies 104 are arranged in series such that air exits the air outlet opening 138B of a first sheet membrane cassette assembly 104 and enters the air inlet opening 136B of a second sheet membrane cassette assembly 104.

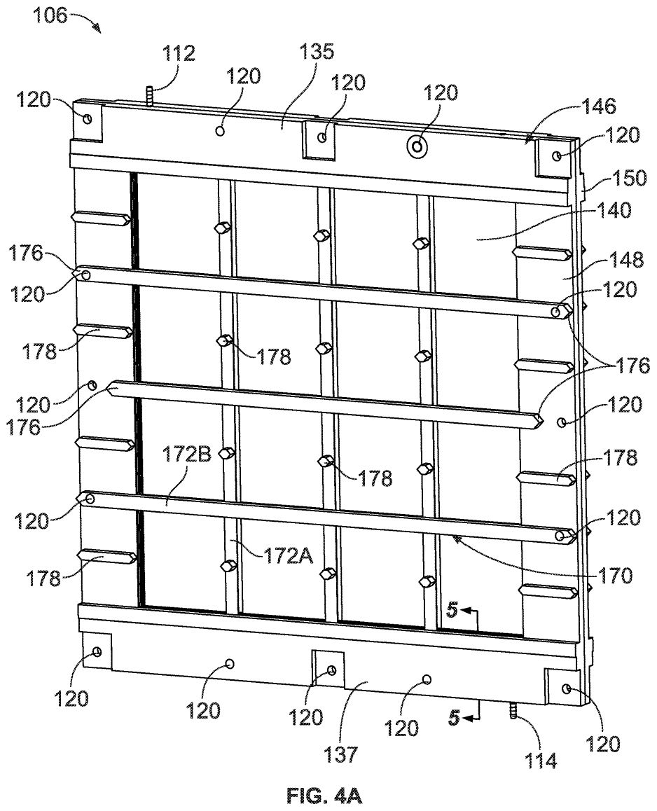

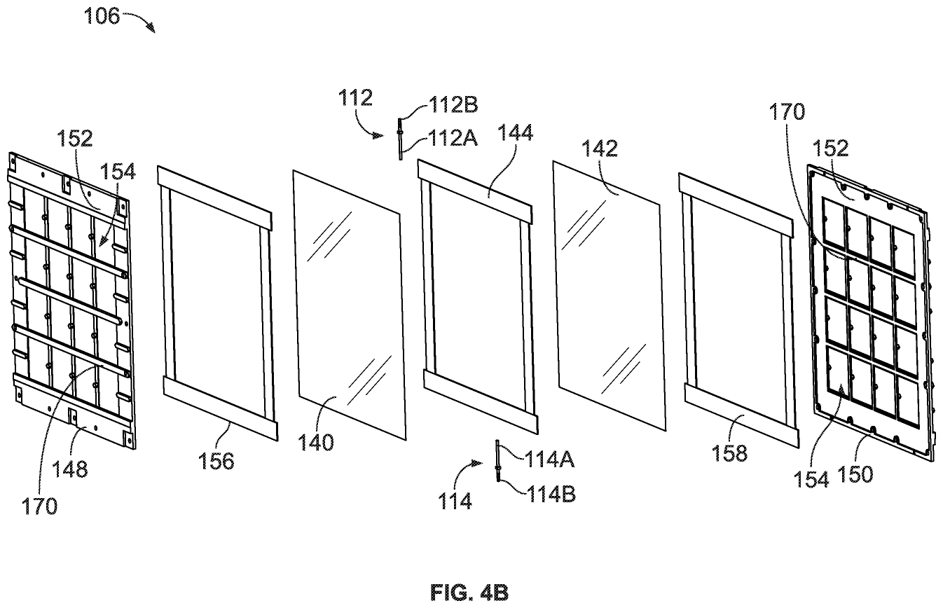

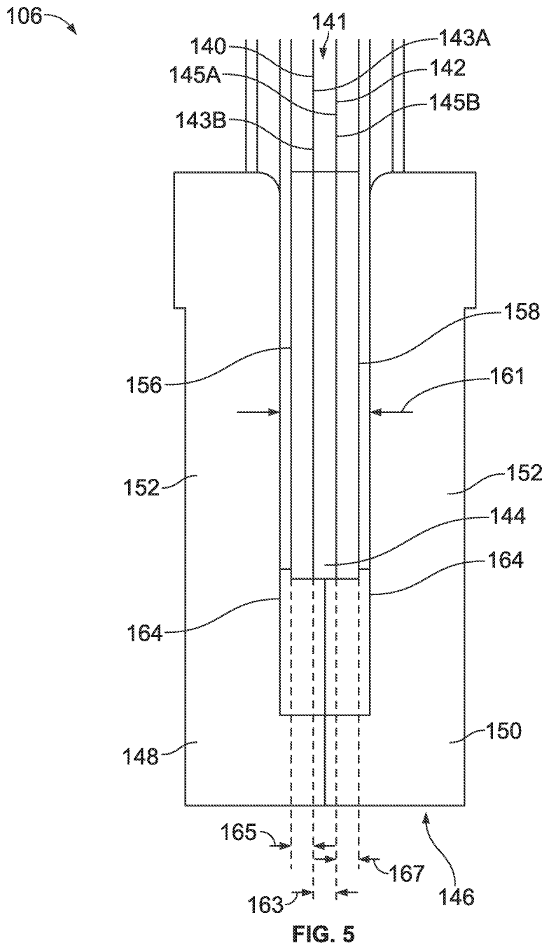

With respect to FIGS. 4A-4B, one of the membrane cassettes 106 is shown in detail. The membrane cassette 106 includes two sheet membranes 140, 142 connected together to form a compartment or interior 141 (see FIG. 5) of the membrane cassette 106 for receiving fluid of the heat exchanger system 100. Fluid may flow into the interior 141 formed between the sheet membranes 140, 142 via an inlet 112 and may flow out of the interior 141 via an outlet 114. The fluid provided to the inlet 112 may be pressurized, such as in the range of approximately 10 psi to approximately 25 psi, such that the pressure in the interior 141 is greater than the pressure outside of the sheet membranes 140, 142.

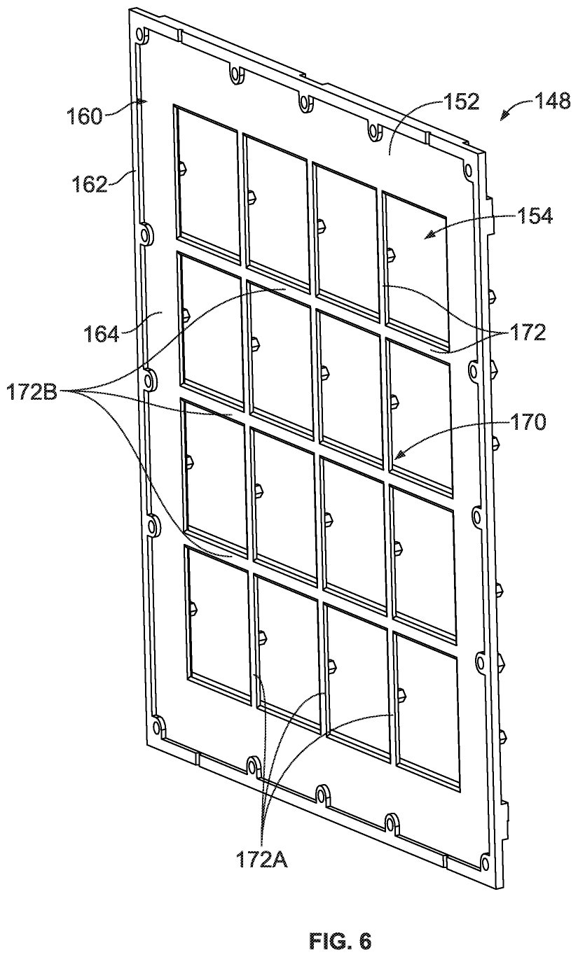

In another embodiment, the fluid provided to the inlet 112 is under a vacuum such that the pressure in the interior 141 is less than the pressure outside of the sheet membranes 140, 142. For embodiments wherein the interior 141 is under a vacuum, the sheet membrane cassettes 106 may include supports in the interior 141 that inhibit the sheet membranes 140, 142 from ballooning inward and contacting each other. The supports in the interior 141 may be similar to the membrane supports 170 discussed below with respect to FIG. 6.

In one embodiment, the sheet membranes 140, 142 are dense membranes such as Ionix Rex II membranes made by Fortescue Future Industries. Dense sheet membranes may be described as sheet membranes without pores larger than 2 nm in diameter. Sheet membranes, including dense sheet membranes, may be flimsy and slippery. From a human handling standpoint, these sheet membranes have a flimsiness and slipperiness similar to wet noodles. The flimsiness of these sheet membranes is attributable to several factors that work together to allow for bulging and/or deformation of the sheet membrane. The factors include the Young's modulus of the membrane material, the flexural modulus of the membrane material, and the second moment of area of the membrane cross section. The second moment of area is determined mostly by the thickness of the sheet membrane. The slipperiness of the sheet membranes is caused by a low coefficient of friction between the sheet membrane and many materials such as ABS plastic and zinc coated steel.

Regarding FIG. 4B, the inlet 112 includes a tube 112A extending into the interior 141 through which fluid may flow into the interior 141. The tube 112A has an end portion 112B which may be connected to the inlet header 111 or a conduit for carrying fluid from another portion of the heat exchanger system 100 (e.g., the inlet header 111). For example, the end portion 112B of the tube 112A may have a barbed fitting for attachment to a tube. The outlet 114 includes a tube 114A extending into the interior 141 of the sheet membranes 140, 142 through which fluid may flow out of the interior 141. The tube 114A has an end portion 114B which may be connected to the outlet header 115 or a conduit for carrying fluid to another portion of the heat exchanger system 100 (e.g., the outlet header 115). For example, the end portion 114B of the tube 114A may have a barbed fitting for attachment to a tube. In some forms, the membrane cassette 106 may include a plurality of inlets 112 and/or a plurality of outlets 114. A plurality of inlets 112 and/or outlets 114 may be used to distribute the fluid flowing through the interior 141, for example, to ensure a large portion of the surface area of the membranes 140, 142 are used to exchange heat.

With reference to FIG. 5, the sheet membranes 140, 142 facilitate heat and/or mass transfer between a first fluid flowing in the interior 141 between inner surfaces 143A, 145A of the sheet membranes 140, 142 and a second fluid flowing along outer surfaces 143B, 145B of the sheet membranes 140, 142. The sheet membranes 140, 142 permit selective mass transfer through the sheet membranes 140, 142. In one embodiment, the sheet membranes 140, 142 are gas-permeable and liquid-impermeable. For example, the sheet membranes 140, 142 may be water vapor permeable and liquid water impermeable. The sheet membranes 140, 142 may each have two or more layers, such as a backing or substrate layer and a selective layer. The substrate layer may include foam and/or non-woven fibers and may have pores with a dimension of 10 micrometers to 50 micrometers. The substrate layer makes the sheet membranes 140, 142 easier to handle during manufacture and strengthens the sheet membranes 140, 142. The selective layer may have no holes or pores at the microscopic level to restrict the permeability of the sheet membranes 140, 142 to particular fluids and/or molecules. The selective layer may be made one or more materials such as polyether block amine (PEBA), two-dimensional nanomaterials such as graphene oxide, siloxane polymers, zeolites, aromatic polyamides, polysulfone, polytetrafluoroethylene (PTFE), sulfonated PTFE, ethyl cellulose, polyethylene oxide/polybutylene terephthalate (PEO-PBT), polydimethylsiloxane (PDMS), sulfonated polyetheretherketone (SPEEK), sulfonated poly(ether sulfone) (SPES), polyetheretherketone (PEEK), and polyethersulfone (PES).

The membrane cassette 106 receives a fluid, such as a fluid including a mixture of liquid and gas that has been heated by the heat exchanger 108. As an example, the fluid entering the interior 141 may be a mixture of water and gaseous water vapor. The sheet membranes 140, 142 permit the water, such as water vapor, that has been heated by the heat exchanger 108 to permeate through the sheet membranes 140, 142 and evaporate into the air directed across the outer surfaces 143B, 145B of the sheet membranes 140, 142. The liquid in the interior 141 between the sheet membranes 140, 142 is thereby cooled by indirect cooling from the airflow over the exterior surfaces of the sheet membranes 140, 142 and the release of higher-energy water vapor through the sheet membranes 140, 142. Evaporation of the water through the sheet membrane 140, 142 may increase the chemical concentration of the fluid and/or density of the solids in the fluid of the heat exchanger system 100 and thus the fluid supply 113 may be used to add fluid to the system 100 to maintain the desired chemical composition of the fluid. For example, where the fluid is a propylene glycol brine, evaporation of water through the sheet membrane increases the concentration of the fluid and thus water may be added with the fluid supply 113 to maintain the desired concentration. Chemicals may also be added to the fluid of the heat exchanger system 100 by the fluid supply 113 to treat the fluid. For example, anti-scalants may be added to the fluid to prevent buildup in the heat exchanger system 100.

With reference to FIG. 5, the sheet membranes 140, 142 may be connected together by a seal member, such as a seal layer 144, to form the interior 141. The seal layer 144 may be positioned at the periphery of the sheet membranes 140, 142 to connect the sheet membranes 140, 142 together about the periphery of the sheet membranes 140, 142. The seal layer 144 may be an adhesive that joins the sheet membranes 140, 142 together and forms a fluid tight seal between the sheet membranes 140, 142 to inhibit fluid from passing therebetween. As discussed below, the seal layer 144 is tightly sandwiched between the sheet membranes 140, 142 during assembly of the cassette 106. Thus, the seal layer 144 is secured to the sheet membranes 140, 142 by both the adhesion of the seal layer 144 to the sheet membranes 140, 142 and the mechanical pressure sandwiching the seal layer 144 between the sheet membranes 140, 142.

In one embodiment, the seal layer 144 includes butyl, such as butyl tape or a butyl extrusion. The butyl tape or butyl extrusion may include one or more materials such as isobutylene-isoprene copolymer (IIR) and isobutylene tripolymer. Butyl has a high surface tack, is highly elastic, and may not harden or melt at temperatures that the seal layer 144 is expected to be exposed to (e.g., −60 [symbol] to 180 [symbol] ). For example, the sheet membrane cassette assembly 104 may be exposed to non-operational ambient temperatures in the range of about −40° F. to 176° F. The operational ambient temperature of the sheet membrane cassette assembly 104 may be in the range of about −20° F. to 140° F., and may even occasionally increase to 150° F. The operational water temperature of the water flowing through the sheet membrane cassette assembly 104 may be in the range of about 36° F. to 130° F.

Butyl also has a low permeability to gases, water vapor, and moisture. The high surface tack of the seal layer 144 ensures the seal layer 144 remains secured to the sheet membranes 140, 142, which often have smooth, nonstick inner surfaces 143A, 145B. A seal layer 144 of high elasticity is advantageous to permit the seal layer 144 to remain secured to the sheet membranes 140, 142 as they expand and to permit the seal layer 144 to be flexible over time to avoid cracking and leaks. A seal layer 144 that remains soft or flexible at low operating temperatures is advantageous because the heat exchanger 102 may be exposed to a wide range of temperatures such as −60 [symbol] to 180 [symbol] during storage, operation, and/or when on standby (e.g., during winter) while remaining secured to the sheet membranes 140, 142 to form the fluid tight seal therebetween. A seal layer 144 that has a low permeability to gases, water vapor, and moisture ensures that a fluid tight seal is maintained to inhibit gasses or fluid from leaking from the interior 141 through the seal layer 144.

In an embodiment where the seal layer 144 is butyl, the butyl may be heated and then extruded as the butyl is applied to a sheet membrane 140, 142 before joining the sheet membranes 140, 142 together. In other embodiments, the seal layer 144 is a butyl tape that is positioned between the sheet membranes 140, 142.

The seal layer 144 may have one or more materials in the seal layer 144 to limit how far the seal layer 144 may be compressed when the sheet membranes 140, 142 are pressed together with the seal layer 144 therebetween. For example, the seal layer 144 may include a shim included in the seal layer 144, such as one or more plastic or rubber members or embedded in a binder material of the seal layer 144. The shim limits compression of the binder material and keeps the binder material from being squeezed out from between the sheet membranes 140, 142. The shim may be, for example, an ethylene propylene diene monomer (EPDM) bead or strip that extends the length of the seal layer 144. For example, the seal layer 144 may include one or more shim strips that form one or more o-rings. The o-rings in the seal layer 144 are compressed between the sheet membranes 140, 142 to resist fluid leaking out of the interior 141.

The shim strip provides a stop to engage the sheet membranes 140, 142 and resist movement of the seal layer 144 relative to the sheet membranes 140, 142. Further, the material of the shim in the butyl provides a solid object for the sheet membranes 140, 142 to press against which facilitates even sealing between the sheet membranes 140, 142 and the seal layer 144,

Other materials that are high-tack, fluid resistant, and able to withstand operating temperatures may also be used for the seal layer 144. As examples, the seal layer 144 may include EPDM, EPDM rubber, ethylene propylene copolymer (EPM), EPM rubber, IIR, and/or isobutylene tripolymer. Suitable materials for the seal layer 144 may include one or more rubber polymer and/or thermoplastic materials. Some seal layers 144 may include, for example, a tackifier (e.g., rosin), a pigment (e.g., carbon black), a filler (e.g., calcium carbonate), and/or a vulcanizing agent (e.g., sulfur). Example seal layers 144 may include silicone sealants, urethane sealants, and hot melt.

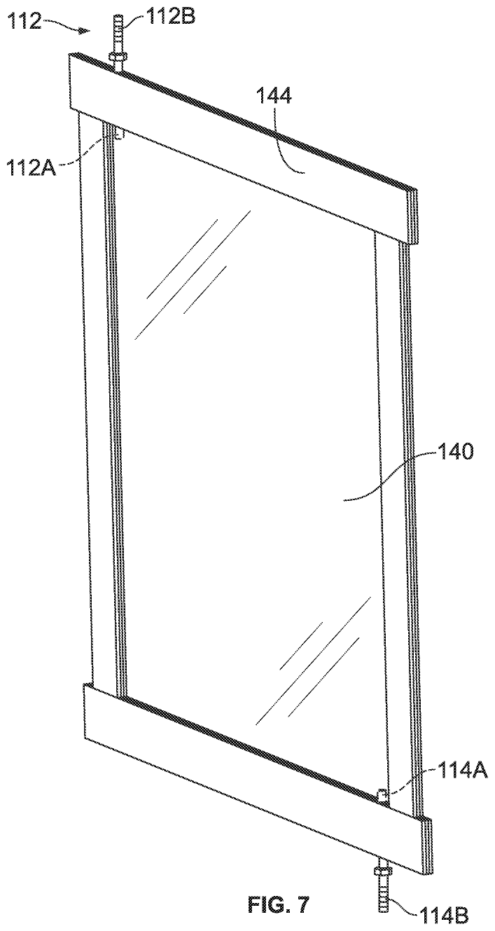

With respect to FIG. 7, the inlet tube 112A and outlet tube 114A may be embedded in the seal layer 144 between the sheet membranes 140, 142 to secure the inlet and outlet tubes 112A, 114A to the sheet membranes 140, 142 and to form a fluid tight seal about the tubes 112A, 114A.

With reference to FIGS. 4B and 5, the membrane cassette 106 includes a clamp, such as support frame 146, that urges the sheet membranes 140, 142 together about the seal layer 144 to firmly engage the sheet membranes 140, 142 with the seal layer 144. The support frame 146 supports the sheet membranes 140, 142, for example, to keep the sheet membranes 140, 142 from kinking, folding, or otherwise collapsing. The support frame 146 is formed by two or more parts joined together, such as a first support and a second support. An example of a first support and a second support is first and second frame members 148, 150 as shown in FIG. 4B. The membrane cassette 106 further include one or more securing members, such as a securing layer 156 between the first frame member 148 and the sheet membrane 140 and a securing layer 158 between the second frame member 150 and the sheet membranes 142. The securing layers 156, 158 may be similar to the embodiments of the seal layer 144 discussed above. For example, in some embodiments, the securing layers 156, 158 are made of the same material as the seal layer 144. In other embodiments, the securing layers 156, 158 are made of a different material than the seal layer 144. The securing layers 156, 158 are positioned between the frame members 148, 150 and the sheet membranes 140, 142 to aid in securing the periphery of the sheet membranes 140, 142 to the frame members 148, 150. Once the sheet membrane cassette assembly 104 has been assembled, the first and second frame members 148, 150 are clamped together which compresses the seal layer 144 between the sheet membranes 140, 142; compresses the securing layer 156 between the frame member 148 and the sheet membrane 140; and compresses the securing layer 158 between the sheet membrane 142 and the frame member 150. The light clamping together of the first and second frame members 148, 150, seal layer 144, securing layers 156, 158, and sheet membranes 140, 142 secures the sheet membranes 140, 142 in the cassette 106 and seals the sheet membranes 140, 142 about the periphery thereof.

The frame members 148, 150 may be similar to one another such that the following discussion of the first frame member 148 applies to the second frame member 150. With reference to FIG. 6, the first frame member 148 includes an outer frame portion 152 that extends about windows or through openings 154 of the first frame member 148. In FIG. 6, the first frame member 148 has sixteen through openings 154. The support frame 146 supports the sheet membranes 140, 142 such that a central portion of the sheet membranes 140, 142 spans across and/or covers the through openings 154 of the frame member 148.

With reference to FIG. 6, the first frame member 148 has a pocket 160 formed in part by a raised portion such as flange 162 and a recessed surface 164. The recessed surface 164 extends about the through openings 154 of the first frame member 148 and is sized to have the securing layer 156 seat thereagainst. The second frame member 150 similarly includes a flange 162 and a recessed surface 164. When the first frame member 148 and second frame member 150 are connected together, the flanges 162 contact one another and provide a stop to limit movement of the first and second frame members 148, 150 together when the membrane cassettes 106 are stacked in the sheet membrane cassette assembly 104. Limiting movement of the first and second frame members 148, 150 toward one another limits the compression of the seal layer 144 and securing layers 156, 158 to ensure that the seal layer and securing layers are not over-compressed. For example, over-compressing the seal layer 144 between the sheet membranes 140, 142 may force a portion of the seal layer 144 to flow out from between the sheet membranes 140, 142 and weaken the seal therebetween. To avoid over-compressing the seal layer 144 and securing layers 156, 158, the seal layer and securing layers may be compressed to about 40% to about 70%, such as 50%, of their original, uncompressed thickness. In one specific example, and with reference to FIG. 5, when the flanges 162 (see FIG. 6) of the first and second frame members 148, 150 contact one another, the distance 161 between the opposing recessed surfaces 164 of the first and second frame members 148, 150 is about 0.25 inches. When uncompressed, the thickness 163, 165, 167 of each of the seal layer 144 and securing layers 156, 158 may be about 0.125 inches. Each uncompressed seal layer and securing layer may have one or more shim members each having a thickness of about 0.0625 inches. When compressed by the first and second frame members 148, 150 as shown in FIG. 5, the seal layer 144 and securing layers 156, 158 may each be compressed to a thickness 163, 165, 167 of about 0.0825 inches or about 66% of their original thicknesses.

The connector rods 118 extending through the attachment openings 120 of frame members 148, 150 of the membrane cassettes 106 resist relative movement of the frame members 148, 150 and keep the frame members 148, 150 in alignment with one another. With reference to FIG. 3, connector rods 118 are sized to extend through the attachment openings 120 of the membrane cassettes 106 to secure the membrane cassettes 106 to one another in the stacked or side-by-side arrangement shown in FIG. 2C. The connector rods 118 each have an enlarged head 118A and a shank depending therefrom with the threaded end portion 121 thereon. The membrane cassettes 106 are captured along the connector rods 118 between the head portion 118A of the connector rods 118 and the nuts 122 engaged with the threaded end portion 121. The sheet membrane cassette assembly 104 may include bolts, screws, washers, engaging portions, and/or detents as desired for a particular embodiment to keep the membrane cassettes 106 assembled and in the side-by-side arrangement.

During assembly of the sheet membrane cassette assembly 104, the nuts 122 are tightened down which clamps the membrane cassettes 106 between the head portions 118A of the connector rods 118 and the nuts 122 (and any washers that may be used). The tightening down of the nuts 122 urges the frame members 148, 150 of each membrane cassette 106 together and compresses the assembly of the sheet membranes 140, 142 and seal layer 144 and securing layers 156, 158 of the membrane cassette 106.

With reference to FIG. 4A, each of the first and second frame members 148, 150 includes one or more membrane supports 170. The membrane supports 170 are positioned to contact the membranes 140, 142 and limit outward expansion or bulging of the sheet membranes 140, 142 through the openings 154 of the first and second frame members 148, 150 when the interior 141 is filled with fluid. Because the membrane supports 170 limit outward expansion of the sheet membranes 140, 142, the membrane supports 170 keep the air flow passageways 128 open and maintain the efficiency of the sheet membrane cassette assembly 104. Further, the membrane supports 170 limit deformation of the sheet membranes 140, 142 which improves the durability of the sheet membranes 140, 142.

For example, the membranes 140, 142 may be formed of a material that expands when wetted by a fluid, for example, as fluid flows through the interior 141 of the membrane cassette 106. The pressure of the fluid in the interior 141 may also force the membranes 140, 142 to balloon or expand outwardly against the membrane supports 170. The membrane supports 170 constrain the sheet membranes 140, 142 from expanding outward into contact with the sheet membranes 140, 142 of the adjacent membrane cassette 106. Contact between sheet membranes 140, 142 of adjacent membrane cassettes 106 may be undesirable as it reduces the surface area of the sheet membranes 140, 142 of the sheet membrane cassette assembly 104 exposed to airflow through the air flow passageways 128 and restricts the flow of air through the air flow passageways 128.

The membrane supports 170 may include struts 172 connected to the outer frame portion 152 that intersect and extend about the through openings 154. The intersecting struts 172 form a grid of rigid members to resist excessive deformation of the sheet membrane 140, 142 facing the struts 172. The grid of struts 172 includes longitudinally extending struts 172A and laterally extending struts 172B. The density of the grid of struts 172 and the number of longitudinally and laterally extending struts 172A, 172B may be selected based on the material of the membrane 140, 142 and/or how far the membranes 140, 142 are permitted to deform when wetted. The struts 172 may include openings formed therein to reduce the surface area of the sheet membranes 140, 142 covered by the struts 172 and provide more surface area for exchanging heat through the sheet membranes 140, 142.

The laterally extending struts 172B may extend outward from the outer frame portion 152 to space the membrane cassette 106 from the adjacent membrane cassette 106. The laterally extending struts 172 may space the outer frame portions 152 of the first and second frame members 148, 150 of adjacent membrane cassettes 106 from one other to form the air flow passageways 128 of the sheet membrane cassette assembly 104. The laterally extending struts 172B may also provide clearance for the sheet membranes 140, 142 to expand. For example, and with reference also to FIG. 2C, the laterally extending struts 172B of adjacent membrane cassettes 106 contact one another to maintain a minimum width of the air flow passageways 128 when the membrane cassettes 106 are stacked side-by-side.

With reference to FIG. 4A, the laterally extending struts 172B may include end portions 176 shaped to direct air flow into and out of the air flow passageways 128 and minimize turbulence. For example, the end portions 176 may taper to a point. Air flowing into the sheet membrane cassette assembly 104 may flow along the tapered surfaces of the end portion 176 and be guided above or below the laterally extending strut 172B. Air flowing out of the sheet membrane cassette assembly 104 may flow along the tapered surfaces of the end portion 176 to smoothly rejoin the air flowing above and below the laterally extending strut 172B and reduce turbulence. The membrane support 170 may further include protrusions 178 positioned between the laterally extending struts 172B and within the air flow passageways 128 of the sheet membrane cassette assembly 104. The protrusions 178 may aid to guide the flow of air through the air flow passageways 128. The protrusions 178 may also contact the protrusions 178 of the adjacent membrane cassette 106 to limit outward movement of the struts 172, for example, as the sheet membranes 140, 142 expand.

With reference again to FIG. 4A, the membrane cassette 106 has a cross-counter-flow configuration that permits air to flow generally obliquely to the flow of fluid through the interior 141. For example, in the orientation shown, the membrane cassette 106 includes the inlet 112 at a top corner of the membrane cassette 106 and the outlet 114 at the opposing bottom corner of the membrane cassette 106 such that fluid flows generally diagonally (e.g., both downwardly and laterally) within the interior 141. Air flows laterally across the sheet membranes 140, 142 in the direction of the laterally extending struts 172B transversely to the flow of fluid in the interior 141. In other forms, the outlet 114 may be at the top end of the membrane cassette 106 and the inlet 112 may be at the bottom end such that fluid flows generally upward within the interior 141.

In another embodiment, the membrane cassette 106 has a crossflow configuration that permits air to flow perpendicular to the flow of fluid through the interior 141. For example, the inlet 112 may be at a top, middle position 135 (see FIG. 4A) of the membrane cassette 106 and the outlet 114 may be positioned at a bottom, middle position 137 of the membrane cassette 106 such that fluid flows generally downwardly within the interior 141. Air flows laterally across the sheet membranes 140, 142 in the direction of the laterally extending struts 172B perpendicular to the flow of fluid in the interior 141. In other forms, the outlet 114 may be at the top end of the membrane cassette 106 and the inlet 112 may be at the bottom end such that fluid flows generally upward within the interior 141.

In another embodiment, the membrane cassette 106 has a parallel flow configuration with the inlet 112 and outlet 114 at opposite lateral sides of the membrane cassette 106. Air flows laterally in a first direction across the sheet membranes 140, 142 from the side of the membrane cassette 106 with the inlet 112 to the side with the outlet 114. Likewise, the fluid in the interior 141 flows generally in the first direction from the inlet 112 to the outlet 114. In yet another embodiment, the inlet 112 and outlet 114 are reversed so that the fluid flows in the interior 141 in a direction opposite the direction of airflow across the membrane cassette 106.

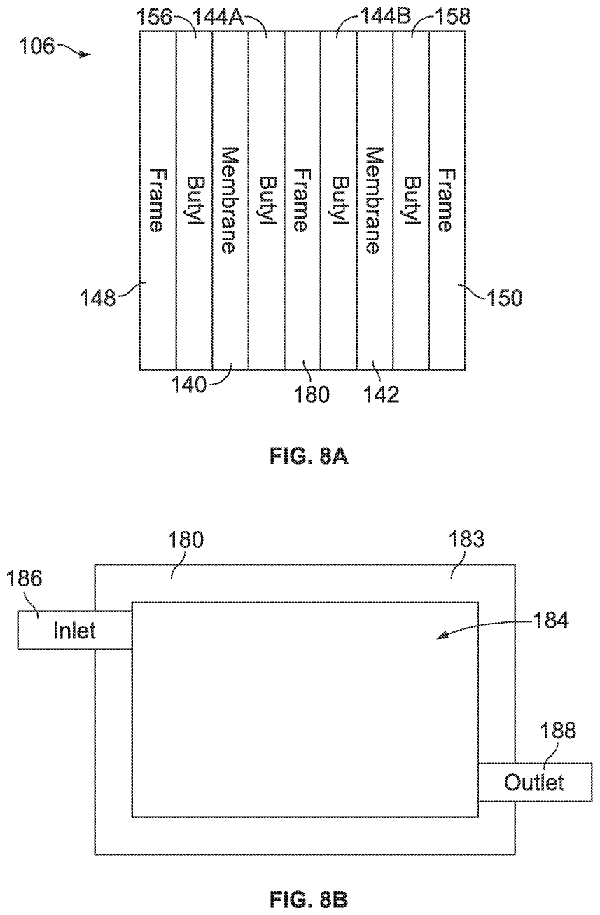

With respect to FIGS. 8A-8B, the membrane cassette 106 may include a spacer such as a central frame member 180. FIG. 8A depicts a schematic diagram showing the layers of the membrane cassette 106 at its periphery (e.g., taken similar FIG. 5) including the central frame member 180 between sheet membranes 140, 142 and two seal layers 144A, 144B. The seal layer 144A is positioned between sheet membrane 140 and the central frame member 180 and the seal layer 144B is positioned between the sheet membrane 142 and the central frame member 180. The seal layers 144A, 144B secure the sheet membranes 140, 142 to the central frame member 180 and form a fluid tight seal therebetween as discussed with respect to the embodiments above. The central frame 180 may aid to support the sheet membranes 140, 142, for example, to keep the periphery of the connected sheet membranes 140, 142 generally flat and maintain a minimum spacing between the sheet membranes 140, 142.

FIG. 8B shows a schematic, side view of the central frame member 180. The central frame member 180 includes a rectangular outer frame 183 extending about an opening 184. The outer frame 183 may be connected to the sheet membranes 140, 142 by the seal layers 144A, 144B about the periphery of the sheet membranes 140, 142. The opening 184 may form a portion of the interior 141 between the sheet membranes 140, 142 through which fluid of the heat exchanger system 100 flows to exchange heat with air flowing over the membrane cassette 106. The central frame member 180 may include an inlet 186 and an outlet 188 through which fluid is able to flow into and out of the interior 141. The inlet 186 and outlet 188 may include ports or tubes of the central frame member 180 that permit fluid to flow through the outer frame 183 of the central frame member 180 and into the opening 184. The inlet 186 and outlet 188 may be ports or tubes attached to the central frame member 180 or may have a unitary, one piece construction with the central frame member 180.

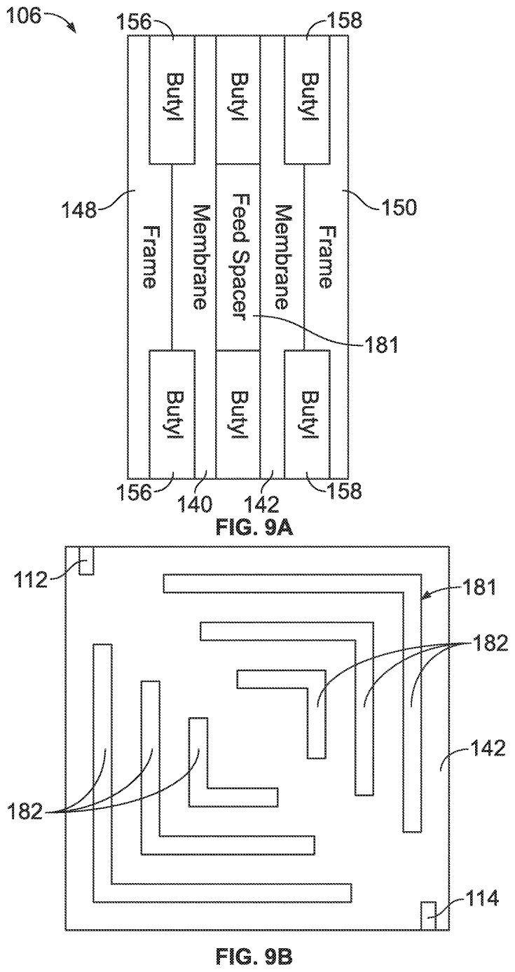

With respect to FIGS. 9A-9B, the membrane cassette 106 may include one or more spacers 181 in the interior 141. FIG. 9A depicts a schematic diagram of the layers of the membrane cassette 106. The membrane cassette 106 includes a spacer 181 in the interior 141 between the sheet membranes 140, 142. The spacer 181 may aid to space the sheet membranes 140, 142 and keep the membranes 140, 142 from sticking to one another. In this manner, the spacer 181 maintains the volume of the interior 141 and preserves a flow path for the fluid through the interior 141.

With respect to FIG. 9B, the spacers 181 may include vanes or baffles 182 that control the flow of fluid through the interior 141. For example, the spacer 181 may include baffles 182 to guide at least a portion of the fluid flowing through the interior 141 to travel along an indirect path from the inlet 112 to the outlet 114. Directing the fluid along an indirect path from the inlet 112 to the outlet 114 may increase the time the fluid is within the interior 141 which may increase the amount of heat exchanged between the fluid and the air flowing along the outer surfaces (e.g., outer surfaces 143B, 145B in FIG. 5) of the sheet membranes 140, 142. Directing the fluid along an indirect path from the inlet 112 to the outlet 114 may also ensure that the entire surface area of the sheet membranes 140, 142 are being used to exchange heat, for example, the corners of the interior 141. The baffles 182 may also disrupt the flow of fluid to mix the fluid as it flows through the sheet membranes to aid in evenly distributing heat throughout the fluid in the interior 141. The spacer 181 may be held in place between the sheet membranes 140, 142 by interference. For example, the baffles 182 may be slightly wider than the distance between the membranes 140, 142 such that the baffles 182 are frictionally engaged with the inner surfaces 143A, 145B (see FIG. 5) of the membranes 140, 142. Alternatively or additionally, the frame members 148, 150 may clamp the spacer 181 therebetween and hold the spacer 181 in place within the interior 141. In some embodiments, the baffles 182 are secured to the membranes 140, 142 by an adhesive and/or heat sealing.

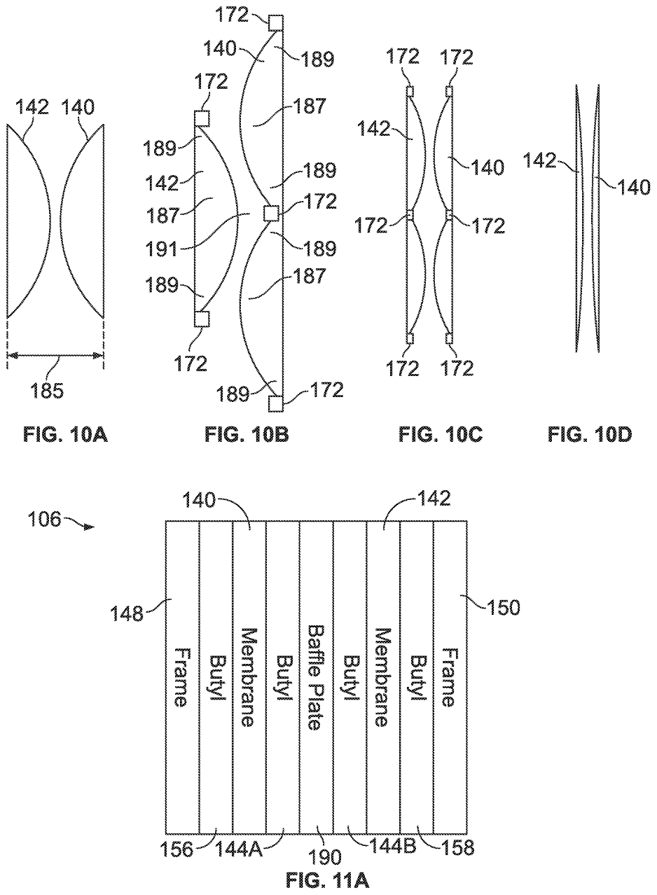

Contact between the sheet membranes 140, 142 of adjacent membrane cassettes 106 may reduce the heat transfer capacity of the sheet membrane cassette assembly 104. To inhibit the sheet membranes 140, 142 from contacting one another, the struts 172 of the first and second frame members 148, 150 restrain the sheet membranes 140, 142 from encroaching too far into the air passageways 128 between the membrane cassettes 106. With respect to FIG. 10A, in another embodiment, the membrane cassettes 106 may be spaced further apart from one another when stacked side-by-side to increase a distance 185 between opposing sheet membranes 140, 142. Spacing the opposing sheet membranes 140, 142 further apart from one another provides additional clearance for the sheet membranes 140, 142 to expand before contacting one another.

With reference to FIG. 10B, in another approach to inhibit the sheet membranes 140, 142 from contacting one another, the struts 172 of adjacent membrane cassettes 106 are vertically offset from one another. For example, the longitudinally extending struts 172A and/or the laterally extending struts 172B of one membrane cassette 106 are offset from the corresponding longitudinally extending struts 172A and/or laterally extending struts 172B of an adjacent membrane 106. Offsetting the struts 172 of the adjacent membrane cassettes 106 controls the areas of the sheet membranes 140, 142 that expand outward toward the opposing sheet membrane 140, 142. For example, portions 187 of the sheet membranes 140, 142 between the struts 172 may balloon or expand outward while portions 189 of the sheet membranes 140, 142 near a strut 172 are more constrained from outward movement by the strut 172. The expanded portions 187 of the sheet membranes 140, 142 may be aligned with the struts 172 of the opposing membrane 140, 142 to position the expanded portions 187 adjacent the portions 189 of the opposing membrane 140, 142 that do not expand outward. In other words, when the sheet membranes 140, 142 are wetted and expand, the expanded portion 187 of the sheet membrane 142 may extend into recesses 191 of the opposing sheet membrane 140 and vice versa. Alternating the position of the expanded portions 187 allows the expanded portions 187 to expand without contacting the opposing sheet membranes 140, 142. Additionally, because the expanded portions 187 extend into the recesses 191 of the opposing sheet membranes 140, 142, the membrane cassettes 106 may be positioned closer to one another which permits the distance between the stacked membrane cassettes 106 to be reduced.

With respect to FIG. 10C, in another approach to inhibit the sheet membranes 140, 142 from contacting one another, the density of the struts 172 of the membrane support 170 is increased. For instance, the distance between the longitudinally extending struts 172A and/or the distance between the laterally extending struts 172B is reduced. Increasing the density of the grid of struts 172 provides smaller openings between the struts 172 through which the sheet membranes 140, 142 are permitted to expand thus limiting the outward expansion of the sheet membranes 140, 142 toward one another.

With respect to FIG. 10D, in another approach to inhibit the sheet membranes 140, 142 from contacting one another, the rigidity of the sheet membranes 140, 142 may be increased to limit outward expansion thereof. For example, the sheet membranes 140, 142 may be formed of more rigid materials to increase the rigidity of the sheet membranes 140, 142, e.g., nickel, siloxane polymers, ceramics, polymers with an added hardening compound, and/or zeolites. In some forms, an additional layer may be added to the sheet membranes 140, 142 to provide support to the selective layer to increase the rigidity. For example, a highly porous, non-woven backing may be utilized to provide increased strength to the sheet membranes 140, 142. Increasing the rigidity of the sheet membranes 140 may also permit the density of the struts of a membrane support 170 to be reduced. In some forms, the membrane cassettes 106 do not include a membrane support 170 as rigidity of the sheet membranes 140, 142 is sufficient to inhibit the opposing sheet membranes 140, 142 from contacting one another.

FIGS. 10A-10D have been discussed with reference to the sheet membranes 140, 142 of a first sheet membrane cassette 106 expanding outward or ballooning toward the sheet membranes 140, 142 of a second sheet membrane cassette 106 due to higher pressure in the first sheet membrane cassette 106. However, the embodiments discussed with respect to FIGS. 10A-10D are applicable for supports within the interior 141 of a sheet membrane cassette 106 that resist sheet membranes 140, 142 of the sheet membrane cassette 106 expanding or ballooning together.

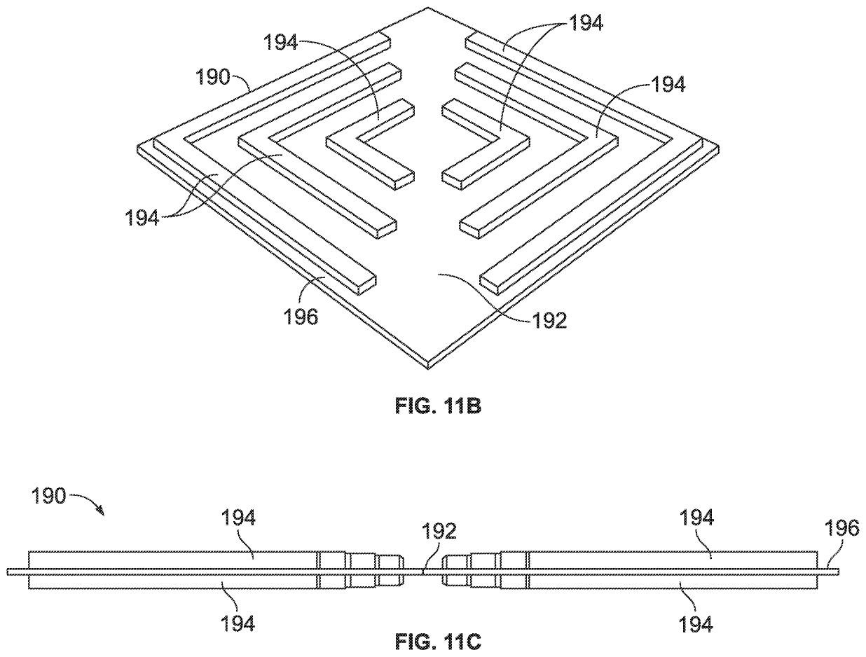

With respect to FIGS. 11A-11C, the membrane cassette 106 may include a spacer such as a baffle plate 190. FIG. 11A depicts a schematic diagram showing the layers of the membrane cassette 106 at its periphery (e.g., taken similarly FIG. 5) including the baffle plate 190 between sheet membranes 140, 142 and two seal layers 144A, 144B. The seal layer 144A is positioned between sheet membrane 140 and the baffle plate 190 and the seal layer 144B is positioned between the sheet membrane 142 and the baffle plate 190. The seal layers 144A, 144B secure the sheet membranes 140, 142 to the baffle plate 190 and form a fluid tight seal therebetween as discussed with respect to the embodiments above. The baffle plate 190 may aid to support the sheet membranes 140, 142, for example, to keep the periphery of the connected sheet membranes 140, 142 generally flat and maintain a minimum spacing between the sheet membranes 140, 142.

FIG. 11A-11B show an example of the baffle plate 190. The baffle plate 190 includes a plate portion 192 with one or more baffles 194 upstanding from the plate portion 192. The plate portion 192 may include a peripheral portion 196 that the seal layers 144A, 144B engage to connect the periphery of the sheet membranes 140, 142 to the plate portion 192 with a fluid tight connection. The peripheral portion 196 of the plate portion 192 may be aligned with the outer frame portion 152 of the first and second frame members 148, 150 such that urging the first and second side frame members 148, 150 together compresses the seal layers 144A, 144B against the peripheral portion 196 to form the fluid tight connection. The baffles 194 may be secured to one or both sides of the plate portion 192 by fasteners and/or an adhesive or may be formed as a single piece with the plate portion 192. The baffles 194 may function similarly to the baffles discussed above, for example, to guide at least a portion of the fluid flowing through the interior 141 of the membrane cassette 106 to travel along a non-linear path from the inlet 112 to the outlet 114.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A, B, and C” is intended to encompass A, B, AB, BC, AC, or ABC.

While there have been illustrated and described particular embodiments of the present invention, it will be appreciated that numerous changes and modifications will occur to those skilled in the art, and it is intended for the present invention to cover all those changes and modifications which fall within the scope of the appended claims.

What is claimed is:

1. A sheet membrane apparatus comprising:
a first sheet membrane and a second sheet membrane to be contacted by a first fluid;
an interior intermediate the first and second sheet membranes to receive a second fluid;
wherein the first and second sheet membranes are configured to permit mass transfer between the first and second fluids via the first and second sheet membranes;
a seal member between the first and second sheet membranes; and
a clamp configured to urge the first and second sheet membranes together to engage the first and second sheet membranes with the seal member.

2. The sheet membrane apparatus of claim 1 wherein the clamp is configured to compress the seal member between the first and second sheet membranes.

3. The sheet membrane apparatus of claim 1 wherein the seal member engages portions of the first and second sheet membranes;
wherein the seal member has an initial, uncompressed thickness; and
wherein the clamp is configured to keep the portions of the first and second sheet membranes a predetermined distance apart that is less than the uncompressed thickness of the seal member such that the seal member is compressed between the portions of the first and second sheet membranes.

4. The sheet membrane apparatus of claim 1 wherein the seal member comprises a butyl tape, a butyl extrusion, or a combination thereof.

5. The sheet membrane apparatus of claim 1 wherein the first and second sheet membranes have outer surfaces to be contacted by the first fluid;
wherein the first and second sheet membranes have inner surfaces opposite the outer surfaces to be contacted by the second fluid; and
wherein seal member is engaged with the inner surfaces of the first and second sheet membranes.

6. The sheet membrane apparatus of claim 1 wherein the clamp comprises a first support and a second support on opposite sides of the first and second sheet membranes;
a first securing member engaged with the first support and the first sheet membrane, the first securing member extending about the interior; and
a second securing member engaged with the second support and the second sheet membrane, the second securing member extending about the interior.

7. The sheet membrane apparatus of claim 6 further comprising a spacer configured to direct a flow of the second fluid in the interior, the spacer between the first and second sheet membranes; and
wherein the seal member comprises:
a first seal member engaged with the first sheet membrane and the spacer; and
a second seal member engaged with the second sheet membrane and the spacer.

8. The sheet membrane apparatus of claim 6 wherein the first securing member and the second securing member each comprise a butyl tape, a butyl extrusion, or a combination thereof.

9. The sheet membrane apparatus of claim 1 wherein the clamp comprises a first frame and a second frame; and
wherein the first and second sheet membranes and seal member are intermediate the first frame and the second frame of the support.

10. The sheet membrane apparatus of claim 9 wherein the first frame has a first opening to permit the first fluid to contact an outer surface of the first sheet membrane; and
wherein the second frame has a second opening to permit the second fluid to contact an outer surface of the second sheet membrane.

11. The sheet membrane apparatus of claim 1 wherein the clamp comprises an interconnected first frame and a second frame;
wherein the first frame includes a first opening that permits the first fluid to contact an outer surface of the first sheet membrane and a plurality of supports extending across the first opening configured to limit outward movement of the first sheet membrane into the first opening; and
wherein the second frame has a second opening that permits the first fluid to contact the second sheet membrane and a plurality of supports extending across the second opening configured to limit outward movement of the second sheet membrane into the second opening.

12. The sheet membrane apparatus of claim 1 wherein the clamp comprises a pair of supports on opposites sides of the first and second sheet membranes; and
stop surfaces of the supports configured to abut and limit movement of the supports toward one another.

13. The sheet membrane apparatus of claim 1 wherein the seal member includes an inlet opening and an outlet opening;
an inlet for the second fluid extending in the inlet opening of the seal member between the first and second sheet membranes; and
an outlet for the second fluid extending in the outlet opening of the seal member between the first and second sheet membranes.

14. The sheet membrane apparatus of claim 1 further comprising a spacer in the interior between first and second sheet membranes; and
wherein the spacer cooperates with the first and second sheet membranes to direct the flow of second fluid in the interior.

15. The sheet membrane apparatus of claim 1 wherein the clamp is configured to compress the seal member between the first and second sheet membranes; and
wherein the seal member comprises binder material and shims in the binder material, the shims configured to limit compression of the seal member.

16. The sheet membrane apparatus of claim 1 wherein the first and second sheet membranes are gas-permeable and liquid-impermeable.

17. The sheet membrane apparatus of claim 1 wherein the first and second sheet membranes each comprise:
a selectively permeable layer; and
a support layer.

18. The sheet membrane apparatus of claim 1 wherein the seal member comprises at least one of:
an isobutylene-isoprene copolymer;
an isobutylene tri-polymer;
an ethylene propylene diene monomer; and
an ethylene propylene copolymer.

19. A sheet membrane system comprising:
an airflow generator;
an inlet header;
an outlet header;
a plurality of sheet membrane cassettes configured to receive a fluid from the inlet header and direct the fluid toward the outlet header, each sheet membrane cassette comprising:
a first sheet membrane and a second sheet membrane to be contacted by air moved by the airflow generator;
an interior defined at least in part by the first and second sheet membranes to receive the fluid;
a seal member between the first and second sheet membranes and engaged therewith; and
supports on opposite sides of the first and second sheet membranes, the supports keeping the first and second sheet membranes engaged with the seal member.

20. The sheet membrane system of claim 19 wherein the seal members of the sheet membrane cassettes are compressed between the first and second sheet membranes.

21. The sheet membrane system of claim 19 wherein the seal members engage portions of the first and second sheet membranes extending about interior;
wherein the seal members each have an initial, uncompressed thickness; and
wherein the supports keep the portions of the sheet membranes a predetermined distance apart that is less than the uncompressed thicknesses of the seal members such that the seal members are compressed between the portions of the first and second sheet membranes.

22. The sheet membrane system of claim 19 wherein the supports include a first support and a second support;
wherein each sheet membrane cassette comprises:
a first securing member engaging the first support and the first sheet membrane, the first securing member extending about the interior; and
a second securing member engaging the second support and the second sheet membrane, the second securing member extending about the interior.

23. The sheet membrane system of claim 19 wherein the sheet membrane cassettes include pairs of sheet membrane cassettes and air passageways formed at least in part by the pairs of sheet membrane cassettes; and
wherein the supports of the pairs of sheet membrane cassettes have openings that open to the air passageways and permit air traveling along the air passageways to contact the first and second sheet membranes of the pairs of sheet membrane cassettes.

24. The sheet membrane system of claim 19 wherein the supports of each sheet membrane cassette comprise a first support and a second support;
wherein each sheet membrane cassette comprises:
a first securing member engaging the first support and the first sheet membrane, the first securing member extending about the interior; and
a second securing member engaging the second support and the second sheet membrane, the second securing member extending about the interior.

25. The sheet membrane system of claim 23 wherein each sheet membrane cassette comprises a spacer in the interior between the first and second sheet membranes, the spacer configured to direct the flow of fluid in the interior; and
wherein the seal member comprises:
a first seal member engaged with the first sheet membrane and the spacer; and
a second seal member engaged with the second sheet membrane and the spacer.

26. The sheet membrane system of claim 19 wherein the sheet membrane cassettes have openings; and
elongate support members extend through the openings of the sheet membrane cassettes to support the sheet membrane cassettes in a side-by-side arrangement.

27. The sheet membrane system of claim 19 wherein the first and second sheet membranes are configured to transfer mass between the air and the fluid.

28. A method of assembling a sheet membrane cassette, the method comprising:
positioning a seal member between a first sheet membrane and a second sheet membrane, the seal member and first and second sheet membranes forming at least a portion of an interior of the sheet membrane cassette;
providing a fluid inlet and a fluid outlet of the sheet membrane cassette; and
clamping the seal member between the first and second sheet membranes to engage the seal member with the first and second sheet membranes and form a fluid-resistant connection therebetween.

29. The method of claim 28 wherein positioning the seal member comprises positioning the seal member between a periphery of the first sheet membrane and a periphery of the second sheet membrane; and
wherein clamping the seal member between the first and second sheet membranes comprises clamping the seal member between the peripheries of the first and second sheet membranes.

30. The method of claim 28 wherein the seal member comprises a first seal member and a second seal member;
the method further comprising positioning a spacer between the first and second sheet membranes; and
wherein positioning the seal member between the first and second sheet membranes comprises:
positioning the first seal member between the first sheet membrane and the spacer; and
positioning the second seal member between the second sheet membrane and the spacer; and
wherein clamping the seal member between the first and second sheet membranes comprises:
clamping the first seal member between the first sheet membrane and the spacer; and
clamping the second seal member between the second sheet membrane and the spacer.

31. The method of claim 28 further comprising positioning first and second supports on opposite sides of the first and second sheet membranes; and
wherein clamping the seal member between the first and second sheet membranes comprises the first and second supports urging the first and second sheet membranes together to compress the sealing member.

32. The method of claim 31 further comprising positioning flexible first and second securing members between the first and second sheet membranes and the first and second supports; and
wherein clamping the seal member between the first and second sheet membranes comprises:
engaging the flexible first securing member with the first support and the first sheet membrane; and
engaging the flexible second securing member with the second support and the second sheet membrane.

33. The method of claim 28 wherein providing the fluid inlet and the fluid outlet comprises:
providing inlet and outlet openings in the seal member; and
positioning the fluid inlet and the fluid outlet in the inlet and outlet openings of the seal member.

34. The method of claim 28 wherein positioning the seal member between the first and second sheet membranes comprises positioning a tape or an extrusion of the seal member between the first and second sheet membranes.

35. The method of claim 28 wherein the first and second sheet membranes are gas permeable and liquid impermeable.
